(19) United States
(12) Patent Application Publication
(10) Pub. No.: US 2026/0030391 A1
(43) Pub. Date: Jan. 29, 2026

(54) METHOD FOR MONITORING ACCESS TO A SOFTWARE OF A CONTROL SYSTEM AND MONITORING SYSTEM

(71) Applicant: FRAMATOME, COURBEVOIE (FR)

(72) Inventor: Jean-Luc JULITA, VILLETTE D'ANTHON (FR)

(21) Appl. No.: 18/997,146

(22) PCT Filed: Jul. 20, 2022
(86) PCT No.: PCT/IB2022/000576

§ 371 Date: Jan. 20, 2025

(51) Int. Cl. G06F 21/86; G06F 21/57

(52) U.S. Cl. CPC G06F 21/86; G06F 21/577

(57) ABSTRACT

A method for monitoring access to software of a control system and monitoring system, the control system including at least one cabinet containing hardware components including software components or giving access to software components. The monitoring method including determining a plurality of physical intrusion ways to the software components for which monitoring is desired; providing tamperproof elements at respective defined marking locations on the hardware components and/or on the cabinet, each tamperproof element having a unique identification code, the marking locations being chosen such that an intrusion through one of the physical intrusion ways causes at least one of the tamperproof elements to be damaged; storing in a database a reference status including the unique identification code of the tamperproof elements and the corresponding marking locations; and during a monitoring phase, checking at least some of the marking locations and comparing with the reference status.

The present disclosure is a means of preventing undetected physical intrusion on a control system. It concerns a method for monitoring access to a software of a control system of an industrial installation.

### BACKGROUND

In sensitive facilities such as nuclear facilities, it is necessary to control the access to the software elements implemented in the control system. Cyber-attacks, carried out using malwares introduced in the software elements, must be prevented since they could lead to potentially catastrophic failures in the facility.

A possibility to control the access to the software elements is to grant physical access only to duly authorized people. However, even with very strict procedures, a possibility always remains that unauthorized people gets physical access to the rooms where the hardware components are accommodated, and modify the software elements without being noticed.

When the intrusion is detected, it can be very difficult in this case to understand how the software elements were accessed and what was done.

### SUMMARY

Accordingly, the present disclosure proposes a method allowing a better monitoring of the access to a software of a control system of an industrial installation.

The method provides as well information to guide the analyses in order to establish a relevant action plan in case of intrusion.

According to a first aspect, the present disclosure concerns a method for monitoring access to a software of a control system of an industrial installation, the control system comprising at least one cabinet containing hardware components comprising software components or giving access to software components, the monitoring method comprising:
determining a plurality of physical intrusion ways to the software components for which monitoring is desired;
providing tamperproof elements at respective defined marking locations on the hardware components and/or on the cabinet, each tamperproof element having a unique identification code, the marking locations being chosen such that an intrusion through one of said physical intrusion ways causes at least one of the tamperproof elements to be damaged;
storing in a database a reference status comprising the unique identification code of the tamperproof elements and the corresponding marking locations; and
during a monitoring phase, checking at least some of the marking locations and comparing with the reference status.

Since the marking locations are determined based of a thorough analysis of the physical intrusion ways to the software components, they are properly arranged. Physical intrusions to the software components is not possible without removing one of the tamperproof elements or damaging one of the tamperproof elements.

Damaged tamperproof elements are immediately visible for operators. For example, a message “Framatome Opened” appears on the tamperproof element.

Missing tamperproof elements are detectable when comparing with the reference status. Every tamperproof has a unique identification code and all identification codes are recorded in the database.

If an intruder replaces an original tamperproof element by another tamperproof element, bearing another identification code, the replacement is easily detected when comparing with the reference status.

The method can be applied all along the life cycle of the control system, from the manufacturing of the cabinets containing hardware components to the commissioning of the control system, and later during the operational life of the control system.

Furthermore, the method allows the company that manufactured the control system to bring a proof of the integrity of the software components, including during the industrial commissioning, when the control system is delivered to the client.

In case an intrusion happens, the method of the present disclosure help understanding how the intruder penetrated the software components, and the chronology of the intrusion.

The method may present one or several of the following features:
during the monitoring phase, checking at least some of the marking locations involves one or several of the following operations:
   checking the physical integrity of the tamperproof elements arranged at said marking locations;
   checking if the identification codes of the tamperproof elements arranged at said marking locations correspond to those of the reference status;
   checking if a tamperproof element is missing compared with the reference status;
during the monitoring phase, checking at least some of the marking locations involves the following operations:
   providing a new tamperproof element at a given marking locations;
   updating the reference status in the database.
   the or each cabinet comprises an outer body and at least one door mounted on the outer body and allowing access to some of the hardware components, one of the tamperproof elements bridging the outer body and the door;
the or each cabinet comprises a chassis, the hardware components being removably mounted to the chassis, the tamperproof elements at the marking locations being arranged:
   bridging two hardware components;
   bridging one of the hardware components and the chassis;
   closing at least one port of one of the hardware components
   bridging a hardware component having a port and a connector inserted inside said port;
an electronic reader is configured for carrying out at least one of the following operations:
   reading the identification code of a tamperproof element;
   providing the marking location associated to the identification code in the reference status;
   recording the identification code of the tamperproof element associated to a given marking location in the reference status.
the method comprises dividing the control system into several areas and each area into several sub-areas, each area comprising at least one cabinet, each sub-area comprising the marking locations accessible through a given door of a given cabinet, the electronic reader being configured for carrying out the following operations:
   reading the identification codes of all the tamperproof elements arranged in a sub-area;
   comparing with the reference status and indicating whether a tamperproof element is missing;
the monitoring phase covers one or several of the following periods:
   a storage period on a manufacturing site where the at least one cabinet has been manufactured;
   a delivery period during which the at least one cabinet is transported from the manufacturing site to the industrial installation;
   a storage period at the industrial installation prior to set up in the industrial installation;
   a set up period during which the at least one cabinet is set up in the industrial installation;
   an operation period during which the at least one cabinet is operated;
in the reference status, each marking location is recorded as in-service or out-of-service, only the marking locations recorded as in-service being checked during the monitoring phase.

According to a second aspect, the present disclosure concerns a monitoring system for monitoring access to a software of a control system of an industrial installation comprising at least one cabinet containing hardware components comprising software components or giving access to software components, the monitoring system comprising:
a database recording marking locations on the hardware components and/or on the cabinet;
tamperproof elements arranged each at one of the marking locations, each tamperproof element having a unique identification code;
   the marking locations being chosen such that an intrusion through a plurality of physical intrusion ways to the software components causes at least one of the tamperproof elements to be damaged;
   the database storing a reference status comprising the unique identification code of the tamperproof elements and the corresponding marking locations.

The monitoring system may present one or several of the following features:
the monitoring system comprises an electronic reader configured for carrying out at least one of the following operations:
   reading the identification code of a tamperproof element;
   providing the marking location associated to the identification code in the reference status;
   recording the identification code of the tamperproof element associated to a given marking location in the reference status.
the or each cabinet comprises an outer body and at least one door mounted on the outer body and allowing access to some of the hardware components, the control system being divided into several areas and each area into several sub-areas, each area comprising at least one cabinet, each sub-area comprising the marking locations accessible through a given door of a given cabinet, the electronic reader being configured for carrying out the following operations:
   reading the identification codes of all the tamperproof elements arranged in a sub-area;
   comparing with the reference status and indicating whether a tamperproof element is missing.
when a checking of a given area/sub-area is carried out, the monitoring system is programmed for recording the following informations:
   all operations carried out at any given marking location, said operations comprising checking said marking location and comparing with the reference status, removing the tamperproof element associated to said marking location and putting a new tamperproof element at said marking location;
   the area, the sub-area, the cabinet, the tamperproof element associated to said given marking location;
   an indication if said given marking location is non-compliant, said given marking location being considered non-compliant if the associated tamperproof element is missing or damaged, or if the identification code of the tamperproof element at the marking location does not correspond to the identification code recorded in the reference status;
   a date and time at which each operation is carried out;
   an identification of the operator who carried out each operation.
the monitoring system is programmed for:
   Extracting data from the database;
   Extracting the reference status from the database;
   Generating detailed reports containing all informations recorded during a given checking;
   Generating a synthesis relating the control system, with all the detailed reports in which at least one non-compliant marking location is mentioned.
in the reference status, each marking location is recorded as in service or out of service.

### BRIEF SUMMARY OF THE DRAWINGS

Other features and advantages of the present disclosure will become apparent from the detailed description of an embodiment below, given as a non limitative example, with regard to the following figures:

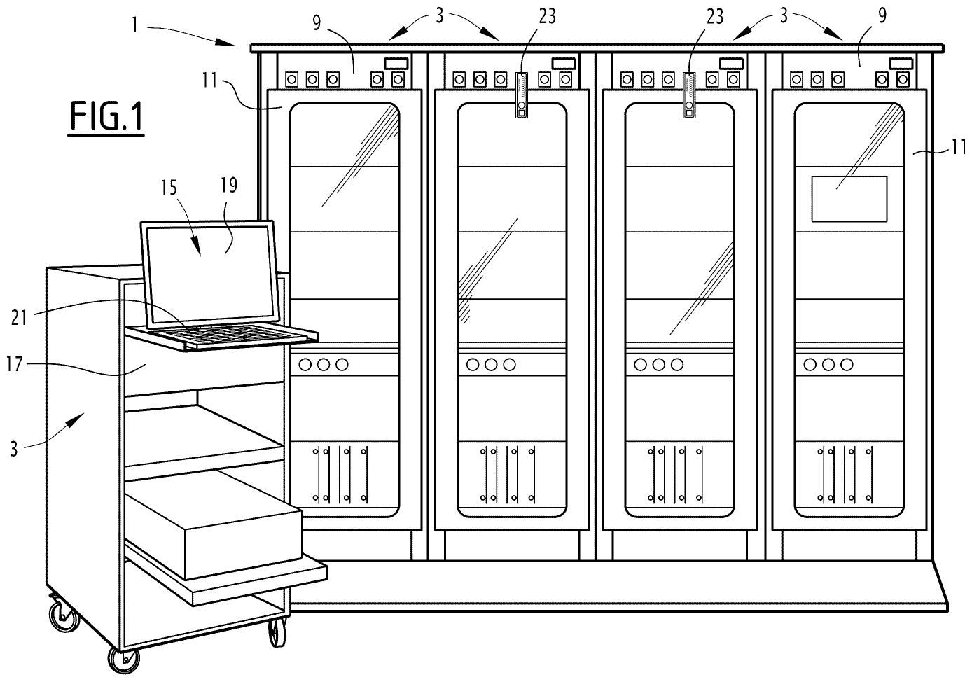

The FIG. 1 is a view of a part of a control system to be monitored;

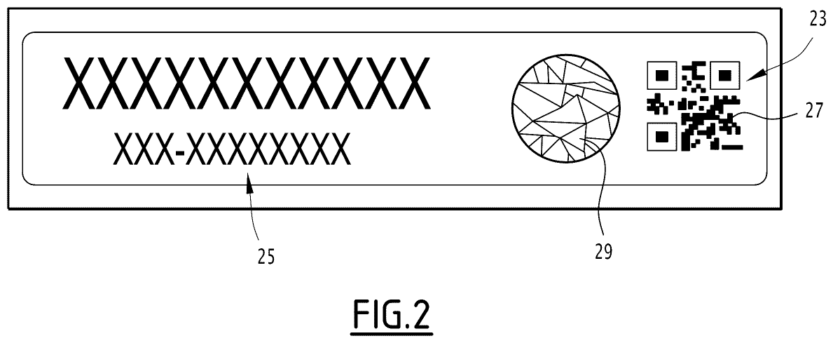

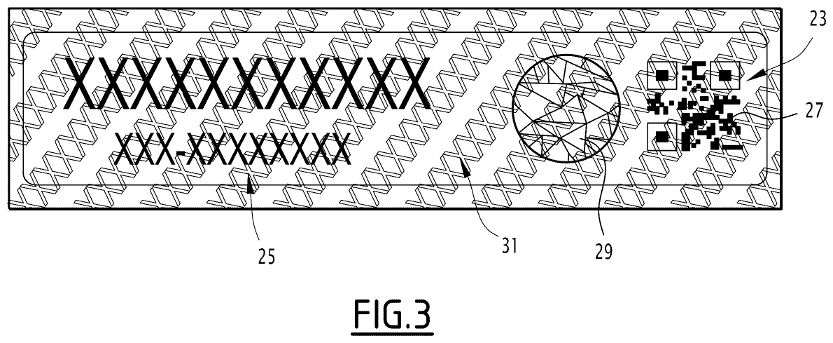

The FIGS. 2 and 3 show a tamperproof element respectively undamaged and damaged;

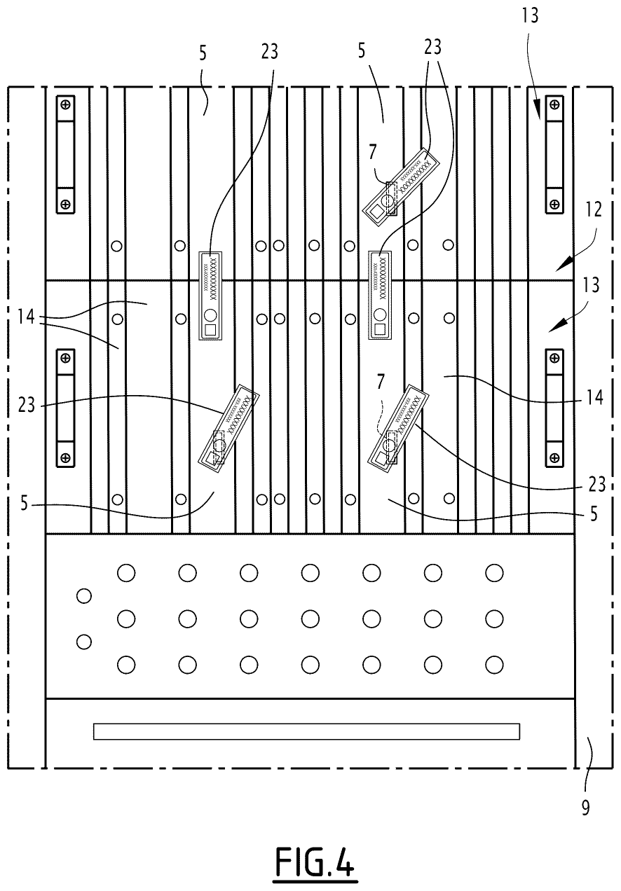

The FIG. 4 depicts several tamperproof elements arranged on marking locations of one of the cabinets shown on the FIG. 1; and

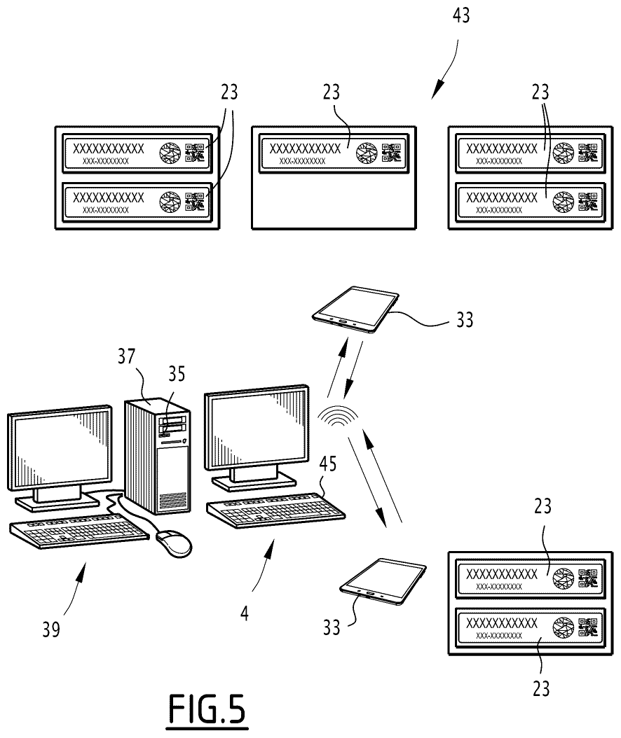

The FIG. 5 is a schematic view of the monitoring system of the present disclosure.

### DETAILED DESCRIPTION

The method described below is for monitoring access to a software of a control system of an industrial installation.

The industrial installation is for example a nuclear facility, such as a nuclear reactor, a nuclear fuel manufacturing plant, a nuclear fuel reprocessing plant, etc.

The installation alternatively is a non-nuclear facility where the penetration of the control system could lead to a potential danger for human beings, for the environment or could be detrimental to the economic interest of the owner of the installation. Said installation could belong to the chemical industry, to the agrochemical industry, to the pharmaceutical industry, to the petrochemical industry, etc.

The control system is the system of the industrial installation that control the operation of the process equipment, or the safety equipment, or any other equipment critical for the safe operation of the industrial installation.

In a nuclear reactor, the method is particularly adapted for monitoring access to the software of the control system controlling the operation of the core of the nuclear reactor. Said control system controls at least the control rods, driven into the core to adjust the reactivity of the nuclear fuel, and to shut down the nuclear reactor in case of emergency.

As shown on the FIG. 1, the control system 1 comprises at least one cabinet 3 containing hardware components 5. The hardware components 5 comprise software components or give access to software components.

In an industry with a critical process, the control system comprises several control sub-systems. The sub-systems are redundant and independent from one another. They are located in independent electrical rooms.

Each system 1, or sub-system, comprises typically several cabinets 3, as shown on the FIG. 1. The cabinets 3 are located in the same room, or are accommodated in different rooms.

The hardware components 5 are:
Components including a memory loaded with a software program, such as a central unit or an EPROM (Erasable Programmable Read-Only Memory);
Components including integrated circuits, such as ASICs (Application Specific Integrated Circuits);
Components with communication ports 7 (FIG. 4) or connectors giving access to the software components;
Computers; etc.

Each cabinet 3 comprises an outer body 9 and at least one door 11 mounted on the outer body 9 and allowing access to some of the hardware components 5.

The outer body 9 and the at least one door 11 completely enclose the hardware components 5. In other words, the hardware components 5 are accessible only when the door 11 is open.

The door 11 is for example a front door, hinged to the outer body 9.

The door 11 alternatively is a side or rear panel, hinged or removably mounted to the outer body 9.

Each cabinet 3 comprises a single door 11, or alternatively comprises several doors 11, each giving access to several hardware components 5.

As shown on the FIG. 4, the cabinet 3 comprises a chassis 12 arranged inside the outer body 9. The hardware components 5 are removably mounted to the chassis 12.

In the example shown, the chassis 12 comprises several racks 13. The hardware components 5 are distributed 7 on several racks 13.

The cabinet 3 accommodates, in addition to the hardware components 5 comprising software components or give access to software components, other hardware components 14 which do not comprise software components and do not give access to software components.

The control system 1 further comprises a cabinet 3 receiving a test device 15. Said cabinet 3 is mobile, since the test device 15 is configured for testing all the sub-systems and must be transported between several rooms.

The test device 15 comprises a computer 17. It has a front door (not shown) for accessing the screen 19 and the keyboard 21 of the computer 17, and a back door (not shown) for accessing the connectors of the computer 17.

The aim of the monitoring method is to detect a physical intrusion to the software components of the control system 1.

The physical intrusion can be for example:
An intruder having access to a hardware component 5 and modifying or replacing the software component included in the hardware component 5;
An intruder having access to a hardware component 5 and replacing the original hardware component 5 by another hardware component including a software component with a malware;
An intruder having access to a communication port 7 or a connector of a hardware component 5 and modifying or replacing the software component included in another hardware component 5.

The monitoring method comprises a first phase of determining a plurality of physical intrusion ways to the software components for which monitoring is desired.

Said phase is usually named engineering phase.

Said phase is carried out usually during the design of the control system 1, before the control system is manufactured.

A physical intrusion way is a way by which an intruder can have physically access to a hardware component containing a software component, or can have physically access to a communication port or a connector giving access to a software component. The physical intrusion way comprises the list of the operations that the intruder must do, considering the physical design of the cabinets 3, to access the hardware component, the communication port or the connector.

The first phase further comprises defining marking locations on the hardware components 5 and/or on the cabinet 3 where tamperproof elements 23 will be put. The marking locations are chosen such that an intrusion through one of said physical intrusion ways causes at least one of the tamperproof elements 23 to be damaged.

The first phase advantageously comprises dividing the control system 1 into several areas and each area into several sub-areas, each area comprising at least one cabinet 3.

Advantageously, each sub-area comprises the marking locations accessible through a given door 11 of a given cabinet 3.

Therefore, each marking location belongs to an identified sub-area, each sub-area belonging to an identified area.

The first phase comprises as well creating a database 35, in which all the marking locations are included, with the corresponding sub-area to which the marking location belongs, and the corresponding area to which the sub-area belongs.

As shown on the FIG. 5, the database 35 is stored in a central server 37.

The central server 37 is located for example in the engineering centre 39, where the first phase takes place. Alternatively, the central server 37 is located at the industrial facility 41.

The monitoring method further comprises providing the tamperproof elements 23 at the respective defined marking locations previously determined, on the hardware components 5 and/or on the cabinets 3.

Each tamperproof element 23 has a unique identification code. The identification code is typically an alphanumerical sequence.

An example of tamperproof element 23 is shown on the FIG. 2.

The tamperproof element is embedded in a label printed on paper or plastic.

It bears on its visible face the unique identification code 25.

It bears a QR code 27, coding the unique identification code.

It bears an hologram 29, making the element tamperproof. The element is not reproducible on a color printer

The name of the company manufacturing the control system may be indicated as well.

The tamperproof element 23 is sticked on the hardware component 5 and/or on the cabinet 3. When the tamperproof element 23 is removed from the surface on which it is sticked, a bottom layer of the tamperproof element 23 deteriorates, an inscription appears.

The tamperproof element 23 after removal has the appearance shown on the FIG. 3. Due to the bottom layer missing, writings 31 appear through the visible surface of the tamperproof element 23.

In the example shown, the word “XXXXXXXXXX” appears on the visible face.

This allows detecting that a tamperproof element has been removed from the marking location at which it was originally arranged.

The tamperproof elements 23 are first arranged at the marking locations after the manufacturing of the corresponding cabinet 3 is completed. The corresponding cabinet 3 is the cabinet on which the tamperproof elements 23 are arranged or accommodating the hardware components 5 on which the tamperproof elements 23 are arranged.

They are preferably set up in the facility where the cabinet 3 is manufactured, before the cabinet 3 is transported to the industrial facility.

Typically, for each cabinet 3, one of the tamperproof elements 23 is bridging the outer body 9 and the door 11 (as shown schematically on the FIG. 1). It is called a door tamperproof element, and the corresponding marking location is called a door marking location.

More precisely, when the cabinet 3 comprises several doors 11, one tamperproof elements 23 is bridging the outer body 9 and each door 11.

Bridging means here that a part of the tamperproof element 23 is sticked to the outer body 9, and another part to the door 11. To open the door 11 and access the hardware components inside the cabinet 3, an intruder must remove the tamperproof element from the door or from the outer body 9.

Inside the cabinet 3, the tamperproof elements 23 at the marking locations are arranged, as shown on the FIG. 4:
bridging two hardware components 5;
bridging one hardware components 5 and one hardware component 14;
bridging one hardware component 5 and the chassis 12;
closing at least one port 7 of one of the hardware components 5.

Here, bridging has the same meaning as before.

When an intruder wants to remove the hardware component 5 from the chassis 12, he must remove at least one tamperproof element 23 from said hardware component 5, or from a neighbouring hardware component 5, 14, or from the chassis 12.

When an intruder wants to access a communication port 7, he must first at least partially remove the tamperproof element 23.

When the marking location corresponds to a communication port in which a connector is engaged (case not shown on the figures), the tamperproof element 23 is arranged such that it bridges the connector and the hardware component 5 on which the communication port is arranged.

When an intruder wants to remove the connector from the communication port to access the communication port or the connector, he must remove the tamperproof element 23 either from the connector or from the hardware component 5.

The monitoring method further comprises storing in the database a reference status comprising the unique identification code of all tamperproof elements put on the cabinets 23 and the corresponding marking locations.

This operation is carried out by operators, at the time the tamperproof elements 23 are arranged at the corresponding marking locations.

The reference status is recorded right after the tamperproof elements are initially arranged at the marking locations. It is later updated, when tamperproof elements are removed or replaced.

This operation is carried out advantageously using an electronic reader 33, that will be described further down.

The electronic reader 33 is a mobile electronic device, typically a pad, or a mobile phone, or a mobile computer, etc.

The operator carries out at least the following operations:
reading the identification code of a tamperproof element 23;
recording the identification code of the tamperproof element 23 and the associated marking location in the reference status.

Said operations are repeated for all the tamperproof elements 23.

The reading is carried out using the electronic reader 33, by scanning the QR code, or by recognizing the identification code written on the visible face of the tamperproof element 23, or by entering manually the identification code using a keyboard, or by any other means.

The recording is done automatically, by transferring the data to the central server 37 and implementing a routine specially designed for said recording.

After the recording, the reference status comprises:
The list of the areas of the control system 1;
For each area, the list of the sub-areas belonging to the area;
For each sub-area, the list of the marking locations belonging to the sub-area;
For each marking location, the identification code of the corresponding tamperproof element 23.

Furthermore, in the reference status, each marking location is recorded as in service or out of service. The status of each marking location (in-service or out-of-service) is for example initially chosen by the administrator of the database, who is usually the cyber-security officer of the industrial installation. It can be updated later by the operator reading the identification codes for the reference status. This allows configuring the reference status as the control system is gradually commissioned on site.

A marking location is recorded as out of service for example if it extends on a hardware component 5 which is not present, or when the hardware component is not loaded with a software component, etc.

A marking location recorded as out of service does not bear a tamperproof element 23 and does not belong to the reference status.

The monitoring method further comprises a monitoring phase, involving checking at least some of the marking locations and comparing with the reference status.

The checking is carried out by an operator, advantageously using the electronic reader 33.

The checking is repeated periodically.

The monitoring phase covers one or several of the following periods:
a storage period on the manufacturing site where the at least one cabinet 3 has been manufactured;
a delivery period during which the at least one cabinet 3 is transported from the manufacturing site to the industrial installation;
a storage period at the industrial installation prior to set up and commissioning in the industrial installation;
a set up period during which the at least one cabinet 3 is set up in the industrial installation;
an operation period during which the at least one cabinet 3 is operated.

Preferably, the monitoring phase covers all the periods above.

Checking at least some of the marking locations involves one or several of the following operations:
checking the physical integrity of the tamperproof elements 23 arranged at the marking locations;
checking if the identification codes of the tamperproof elements 23 arranged at the marking locations correspond to those of the reference status;
checking if a tamperproof element 23 is missing compared with the reference status.

Only the marking locations recorded as in-service are checked during the monitoring phase.

If a tamperproof element 23 is damaged or missing, or if the identification code of the tamperproof element 23 does not correspond to the identification code recorded in the reference status, the marking location and the corresponding tamperproof element are considered as “non-compliant”. A cybersecurity event is declared by the operator and recorded. At least the following information is recorded: marking location of the non-compliant tamperproof element 23, type of non-compliance, identification code of the non-compliant tamperproof element 23.

The checking is carried out by an operator, assisted by a monitoring system. The monitoring system is a traceability tool. The electronic reader 33 is a part of the traceability tool. The monitoring system is described below.

More precisely, during a checking operation, an operator first checks the integrity of the door tamperproof element 23 of one or several sub-areas.

If a door tamperproof element 23 of a sub-area is “non-compliant”, it is necessary to check the integrity of all tamperproof elements 23 placed in the sub-area accessible through the door.

As a reminder, the non-compliant tamperproof element 23 can be:
Missing;
Damaged;
Replaced by another tamperproof element 23 (inconsistency of identification code with respect to the reference status).

Checking the integrity of all tamperproof element 23 placed in the sub-area involves the following initial actions:
Recording of the marking location where the non-compliant door tamperproof element 23 was detected, using the traceability tool;
Scanning and recording of the identification code of the non-compliant door tamperproof element 23, using the electronic reader 33, if the door tamperproof element 23 is still present;
Recording of the type of non-compliance, using a drop-down menu of the traceability tool;
Declaration and recording of a cybersecurity event with the authorities;
Information of the event file number declared in the traceability tool.

Then, all tamperproof elements 23 present in the sub-area are checked. If the operator forgets to check a marking location, the traceability tool informs the operator of its oversight. The operator checks the forgotten tamperproof element 23. The information listed above are recorded for all non-compliant marking locations.

At the end of the checking, all the marking locations declared as non-compliant are secured.

New tamperproof elements 23 are placed at the non-compliant marking locations, and the database is updated with the identification codes of the new tamperproof elements 23.

To do this the operator:
Designates the marking location on the traceability tool;
Put the new tamperproof element 23 at the designated marking location;
Scans the identification code of new tamperproof element 23, using the electronic reader 33.

In other words, during the monitoring phase, checking at least some of the marking locations involves the following operations:
removing a tamperproof element 23 at a given marking location;
updating the reference status in the database 35.

A tamperproof element 23 is removed because it is damaged, or because a physical intervention is necessary on the corresponding hardware component 5.

During the monitoring phase, checking at least some of the marking locations involves as well the following operations:
providing a new tamperproof element 23 at a given marking location;
updating the reference status in the database 35.

A new tamperproof element 23 is provided for example when the marking location is shifted from the status out-of-service to the status in-service, or in replacement of a damaged tamperproof element 23.

After each checking operation, the traceability tool generates a control report. The following elements are present in the report:
The name of the control system that was checked during the checking operation;
The checking summary status: OK or NOK
The date and time of the start of the checking, the end time of the checking
The name of the operator who carried out the checking
For all marking locations that were checked:
   Identification of the marking location
   Identification code of the tamperproof element present at the marking location
In the event a non-compliance is detected:
   The marking location which was detected as non-compliant
   The cause of the non-compliance
   The identification code of the non-compliant tamperproof element
   The identification code of the new tamperproof element put to secure the location.

The control report comprises, for each marking location in the sub-area, a comment regarding the situation of the marking location and/or the tamperproof element 23 arranged at said marking location.

The checking is OK if the situation for all the marking locations is identical to the situation recorded in the reference status. It is not OK if the situation at at least one marking location is not identical to the situation recorded in the reference status.

The situation at a given marking location is not identical if the tamperproof element is missing, is damaged, has an identification code different from the identification code recorded in the reference status.

The comment for each marking location indicates the status at the marking location compared to the reference status.

The comment can indicate that a new tamperproof element has been provided but not referenced in the reference status, or that the existing tamperproof element was removed.

The comment indicates if the marking location is out-of-service.

Periodically, an history for the control system 1 can be issued by the traceability tool.

The history is a list, in chronological order, of the following events:
arrangement or removal of a tamperproof element at a marking location;
all the operations carried out by the operators during the checkings;
problems detected: tamperproof element missing, damaged, inconsistent with the reference status;
status of a marking location shifted between in-service and out-of-service.

A monitoring system 43 will now be described.

The monitoring system is a traceability tool.

The monitoring system 43 is for monitoring access to a software of a control system 1 of an industrial installation.

The control system 1 comprises at least one cabinet 3 containing hardware components 5 comprising software components or giving access to software components.

The control system 1 is as described above.

The monitoring system 43 is specially designed for implementing the monitoring method described above. Conversely, the monitoring method above is particularly adapted for being carried out by mean of the monitoring system 43.

The monitoring system 43 comprises:
a database 35 recording marking locations on the hardware components 5 and/or on the cabinet 3;
tamperproof elements 23 arranged each at one of the marking locations, each tamperproof element 23 having a unique identification code.

The marking locations are chosen such that an intrusion through a plurality of physical intrusion ways to the software components causes at least one of the tamperproof elements 23 to be damaged.

The tamperproof elements 23 are as described above.

The marking locations are as described above.

The database 35 stores a reference status comprising the unique identification code of the tamperproof elements 23 and the corresponding marking locations.

In the reference status, each marking location is recorded as in service or out of service.

The database 35 is as described above.

The monitoring system 43 comprises an electronic reader 33 configured for carrying out at least one of the following operations:
reading the identification code of a tamperproof element 23;
providing the marking location associated to the identification code in the reference status;
recording the identification code of the tamperproof element 23 associated to a given marking location in the reference status.

The electronic reader 33 is configured as well for carrying out the following operations:
reading the identification code of a tamperproof element 23 that is removed from a given marking location;
updating the reference status in the database 35 with the indication that said tamperproof 23 was removed and that no tamperproof element is arranged in said marking location.

The electronic reader 33 is further configured for carrying out the following operations:
reading the identification code of a new tamperproof element 23 provided at a given marking location;
updating the reference status in the database 35, by associating said identification code with the marking location.

The electronic reader 33 is further configured for carrying out the following operations:
reading the identification codes of all the tamperproof elements 23 arranged in a sub-area;
comparing with the reference status and indicating whether a tamperproof element 23 is missing.

The monitoring system 43 typically comprises several electronic readers 33, so that several operations can be performed simultaneously in the installation.

As indicated above, each electronic reader 33 is a mobile electronic device, typically a pad, or a mobile phone, or a mobile computer, etc.

The electronic reader 33 communicates with a server 45 located in the industrial installation 41, by Wifi or any other suitable means. The server 45 communicates with the central server 37 hosting the database 35, by Wifi, or by any other suitable means.

When an operator has to carry out an operation using the electronic reader 33, the cyber-security officer of the industrial installation first gives to the operator the rights to carry out the checking in one or several defined areas/sub-areas.

Each sub-area has an identification code, depicted on a label fixed near the sub-area.

When the sub-area corresponds to the marking locations accessible through a given door 11 of a given cabinet 3, said identification code is arranged on the door 11.

The electronic reader 33 offers several routines to the operator:
Routine “Area”
Routine “Arrangement of a tamperproof element”
Routine “Removal of a tamperproof element”
Routine “Checking”.

When the operator selects the routine “Area”, the electronic reader 33 provides him with the tree of the areas of the control system 1.

The operator selects a given area, and first has to check that he is allowed to operate in the selected area.

For that, the operator reads the identification code of a sub-area, for example on the door 11, using the electronic reader 33, and the electronic reader 33 indicates if the operator is granted the right to carry out the operations in the sub-area or not.

The operator then can read on the electronic reader a tree with the sub-areas and marking locations of each sub-area. For each marking location, the electronic reader 33 provides the identification code of the tamperproof element 23 arranged at said marking location if any, and the status of the marking location (in-service, out-of-service).

When the operator selects the routine “Arrangement of a tamperproof element”, the electronic reader 33 provides him with the tree of the areas of the control system 1.

The operator selects a given area, and checks that he is allowed to operate in the selected area, in the same manner as for the routine “Area”.

The electronic reader 33 then displays a tree of the sub-areas and a list of the marking locations belonging to each sub-area.

The operator may, for each marking location, activate a button for reading the identification code of the tamperproof element 23 arranged at the marking location. The reading is carried out before or after the tamperproof element is arranged at the marking location.

The electronic reader 33 will then scan the QR code on the tamperproof element 23 and write the code into the database.

The operator may as well, for each marking location, activate a button for changing the status of the marking area between in-service and out-of-service.

The operator for example shifts the status to out-of-service if the marking location is left without tamperproof element.

When the operator selects the routine “Removal of a tamperproof element”, the electronic reader 33 provides him with the tree of the areas of the control system 1.

The operator selects a given area, and checks that he is allowed to operate in the selected area, in the same manner as for the routine “Area”.

The electronic reader 33 then displays a tree of the sub-areas and a list of the marking locations belonging to the sub-area.

The operator may, for each marking location, activate a button for reading the identification code of the tamperproof element 23 to be removed.

The electronic reader 33 then scans the QR code on the tamperproof element 23 and displays the code for the operator to check it.

If the information relating to the tamperproof element is correct, the operator confirms that the tamperproof element 23 will be removed, and the electronic reader 33 update the database by writing that the tamperproof element 23 has been removed and that the marking location does not have a tamperproof element 23 anymore.

The operator may as well, for each marking location, activate a button for declaring a non-compliance. The electronic reader 33 then displays a new screen with a list of anomalies: tamperproof element 23 missing, damaged, un-sticked, identification code not consistent with the reference status.

The operator then must indicate if the tamperproof element is readable or not. If the tamperproof element is readable, the electronic reader 33 displays a new screen for reading the identification code of the tamperproof element. If the tamperproof element is not readable, the electronic reader 33 requires the operator to indicate manually the marking position associated to the tamperproof element 23.

When the operator selects the routine “Checking”, the electronic reader 33 provides him with the tree of the areas of the control system 1.

The operator selects a given area, and checks that he is allowed to operate in the selected area, in the same manner as for the routine “Area”.

The electronic reader 33 then displays a screen with two possibilities: unitary checking of the sub-areas or serial checking the sub-areas.

If unitary checking is selected, a list of the sub-areas is displayed. The operator selects a sub-area and the electronic reader 33 displays a new screen for reading the identification code of the tamperproof element 23 arranged on the door 11 giving access to said sub-area. The electronic reader then indicates if the identification code read corresponds to the identification code recorded in the reference status.

Before reading the identification code, he checks the integrity of the tamperproof element 23 and declares a non-compliance if the tamperproof element 23 is damaged or missing. He proceeds for that as described above.

After finishing with one sub-area, the operator selects another sub-area, and continues until all sub-areas are checked.

If the serial checking is selected, the electronic reader 33 displays a new screen for reading the identification codes. The operator reads the tamperproof elements 23 arranged on the doors 11 giving access to all sub-areas one after another. The electronic reader indicates if the identification codes read correspond to the identification codes recorded in the reference status.

The operator checks the integrity of the tamperproof elements 23 before the serial checking and declares a non-compliance if necessary.

If the tamperproof elements 23 arranged on the doors 11 giving access to all sub-areas are OK (no anomaly, identification code identical to the reference status), all the sub-areas are indicated OK in the database and the operator press on the button “End of the checking”.

If the tamperproof element 23 arranged on one of the doors 11 is not OK (non-compliance, identification code not identical to the reference status), it is necessary to check the marking locations in the sub-area accessible via said door 11. The sub-area is marked not OK in the database.

The operator then removes the tamperproof element 23 arranged on said door and select the corresponding sub-area on the screen of the electronic reader 33.

The electronic reader 33 then displays the list of the marking locations belonging to selected the sub-area, with a button “Checking” associated to each marking location.

The electronic reader 33 displays as well a button “Serial checkings”.

The checkings can be unitary.

The operator presses on the “Checking” button associated to a marking location and the electronic reader 33 displays a new screen for reading the identification code of the tamperproof element 23 arranged at the marking location. The electronic reader then indicates if the identification code read corresponds to the identification code recorded in the reference status.

Before reading the identification code, the operator checks the integrity of the tamperproof element 23 and declares a non-compliance if the tamperproof element 23 is damaged or missing. He proceeds for that as described above.

After finishing with one marking location, the operator presses on the “Checking” button associated to another marking location, and continues until all marking locations are checked.

[If the button “Serial checkings” is selected, the electronic reader 33 displays a new screen for reading the identification codes. The operator reads the tamperproof elements 23 arranged on all marking locations one after another. The electronic reader indicates if the identification codes read correspond to the identification code recorded in the reference status.

The electronic reader further indicates if one checking is missing in the sub-area compared with the listed checking in reference status. The operator look at the missing checking and report a non-compliance if the tamperproof element 23 is damaged or missing.

The operator checks the integrity of the tamperproof elements 23 before the serial checkings.

Once the marking locations of all the sub-areas which were marked “not OK” have been checked, the operator presses on the button “End of the checking”.

The central cybersecurity officer can access the databases of all the industrial installations, relating to all the control systems of each industrial installation. He can access all the control reports and the history of all the control systems.

Having access to all these information is critical when the central cybersecurity officer must analyze an intrusion and decide actions following the intrusions.

The local security officer and the operators of a given industrial installation can access only the information relating to the control system of said given industrial site.

The reproduction of a tamperproof element by a non-authorized person is more difficult due to the design of the tamperproof element and because Framatome works directly with a manufacturer of tamperproof elements. Only Framatome can order tamperproof elements with the specific design used in the industrial facilities of Framatome.

What is claimed is:

1-15. (canceled)

16. A method for monitoring access to a software of a control system of an industrial installation, the control system comprising at least one cabinet containing hardware components comprising software components or giving access to software components, the monitoring method comprising:
determining a plurality of physical intrusion ways to the software components for which monitoring is desired;
providing tamperproof elements at respective defined marking locations on the hardware components and/or on the cabinet, each tamperproof element having a unique identification code, the marking locations being chosen such that an intrusion through one of said physical intrusion ways causes at least one of the tamperproof elements to be damaged;
storing in a database a reference status comprising the unique identification code of the tamperproof elements and the corresponding marking locations; and
during a monitoring phase, checking at least some of the marking locations and comparing with the reference status.

17. The method according to claim 16, wherein during the monitoring phase, checking at least some of the marking locations involves one or several of the following operations:
checking a physical integrity of the tamperproof elements arranged at said marking locations;
checking if the identification codes of the tamperproof elements arranged at said marking locations correspond to those of the reference status; and
checking if a tamperproof element is missing compared with the reference status.

18. The method according to claim 16, wherein during the monitoring phase, checking at least some of the marking locations involves the following operations:
providing a new tamperproof element at a given marking location; and
updating the reference status in the database.

19. The method according to claim 16, wherein the or each cabinet comprises an outer body and at least one door mounted on the outer body and allowing access to some of the hardware components, one of the tamperproof elements bridging the outer body and the door.

20. The method according to claim 16, wherein the or each cabinet comprises a chassis, the hardware components being removably mounted to the chassis, the tamperproof elements at the marking locations being arranged:
bridging two hardware components;
bridging one of the hardware components and the chassis;
closing at least one port of one of the hardware components; and
bridging a hardware component having a port and a connector inserted inside said port.

21. The method according to claim 16, wherein an electronic reader is configured for carrying out at least one of the following operations:
reading the identification code of a tamperproof element;
providing the marking location associated to the identification code in the reference status; and
recording the identification code of the tamperproof element associated to a given marking location in the reference status.

22. The method according to claim 21, wherein the or each cabinet comprises an outer body and at least one door mounted on the outer body and allowing access to some of the hardware components, one of the tamperproof elements bridging the outer body and the door, and wherein the method comprises dividing the control system into several areas and each area into several sub-areas, each area comprising at least one cabinet, each sub-area comprising the marking locations accessible through a given door of a given cabinet, the electronic reader being configured for carrying out the following operations:
reading the identification codes of all the tamperproof elements arranged in a sub-area; and
comparing with the reference status and indicating whether a tamperproof element is missing.

23. The method according to claim 16, wherein the monitoring phase covers one or several of the following periods:
a storage period on a manufacturing site where the at least one cabinet has been manufactured;
a delivery period during which the at least one cabinet is transported from the manufacturing site to the industrial installation;
a storage period at the industrial installation prior to set up in the industrial installation;
a set up period during which the at least one cabinet is set up in the industrial installation; and
an operation period during which the at least one cabinet is operated.

24. The method according to claim 16, wherein in the reference status, each marking location is recorded as in-service or out-of-service, only the marking locations recorded as in-service being checked during the monitoring phase.

25. A monitoring system for monitoring access to a software of a control system of an industrial installation, the control system comprising at least one cabinet containing hardware components comprising software components or giving access to software components, the monitoring system comprising:
a database recording marking locations on the hardware components and/or on the cabinet;
tamperproof elements arranged each at one of the marking locations, each tamperproof element having a unique identification code;
the marking locations being chosen such that an intrusion through a plurality of physical intrusion ways to the software components causes at least one of the tamperproof elements to be damaged; and
the database storing a reference status comprising the unique identification code of the tamperproof elements and the corresponding marking locations.

26. The monitoring system according to claim 25, wherein the monitoring system comprises an electronic reader configured for carrying out at least one of the following operations:
reading the identification code of a tamperproof element;
providing the marking location associated to the identification code in the reference status; and
recording the identification code of the tamperproof element associated to a given marking location in the reference status.

27. The monitoring system according to claim 26, wherein the or each cabinet comprises an outer body and at least one door mounted on the outer body and allowing access to some of the hardware components, the control system being divided into several areas and each area into several sub-areas, each area comprising at least one cabinet, each sub-area comprising the marking locations accessible through a given door of a given cabinet, the electronic reader being configured for carrying out the following operations:
reading the identification codes of all the tamperproof elements arranged in a sub-area; and
comparing with the reference status and indicating whether a tamperproof element is missing.

28. The monitoring system according to claim 27, wherein, when a checking of a given area/sub-area is carried out, the monitoring system is programmed for recording the following information:
all operations carried out at any given marking location, said operations comprising checking said marking location and comparing with the reference status, removing the tamperproof element associated to said marking location and putting a new tamperproof element at said marking location;
the area, the sub-area, the cabinet, the tamperproof element associated to said given marking location;
an indication if said given marking location is non-compliant, said given marking location being considered non-compliant if the associated tamperproof element is missing or damaged, or if the identification code of the tamperproof element at the marking location does not correspond to the identification code recorded in the reference status;
a date and time at which each operation is carried out; and
an identification of the operator who carried out each operation.

29. The monitoring system according to claim 28, wherein the monitoring system is programmed for:
extracting data from the database;
extracting the reference status from the database;
generating detailed reports containing all information recorded during a given checking; and
generating a synthesis relating the control system, with all the detailed reports in which at least one non-compliant marking location is mentioned.

30. The monitoring system according to claim 25, wherein in the reference status, each marking location is recorded as in service or out of service.
